(19) United States
(12) Patent Application Publication
(10) Pub. No.: US 2015/0081315 A1
(43) Pub. Date: Mar. 19, 2015

(54) METHOD FOR SELECTING MEDICAL IMAGING PROTOCOLS

(71) Applicant: Stephen Baker, Iowa City, IA (US)

(72) Inventor: Stephen Baker, Iowa City, IA (US)

(73) Assignee: RADIOLOGY RESOURCES INTERNATIONAL, LLC, Iowa City, IA (US)

(21) Appl. No.: 14/026,825

(22) Filed: Sep. 13, 2013

(51) Int. Cl. G06Q 50/22; G06Q 10/10

(52) U.S. Cl. CPC G06Q 50/22; G06Q 10/10
USPC 705/2

(57) ABSTRACT

A method for selecting medical imaging protocols. The method allows a physician to input client history to generate a series of available protocols associated with medical imaging modalities available to the patient. The method ranks the protocols in order of appropriateness. The method allows the physician to select a desired protocol, which protocol may be reviewed, approved, rejected, or modified by a radiologist. Once the radiologist approves of the protocol and orders and examination based upon the protocol, a technician uses a diagnostic imaging system to generate images of the patient associated with the protocol which may be reviewed by the radiologist to generate an exam whereafter both the images and exam may be used by the physician to diagnose or treat the patient.

### FIELD OF THE INVENTION

The present invention relates in general to a method for facilitating communication between a physician and radiologist and, more specifically, to a method for facilitating the ability of a physician and radiologist to determine appropriate patient protocols for medical imaging using various modalities.

### BACKGROUND OF THE INVENTION

Creating various images of the human body for medical purposes, otherwise know as medical imaging, is well known in the art. Medical imaging can involve different modalities, such as computed axial tomography (CAT scan), computed tomography (CT), magnetic resonance imaging (MRI), positron emission tomography (PET), ultrasound, and others. Each modality has a particular protocol for a generating a particular medical image. A protocol may include such specifications as scanning speed, contrast, focal point, rotation rate, etc.

To manage images generated through these various modalities and protocols, medical centers often create internal databases. Such databases are useful for storing and retrieving medical images, but they are less useful for providing guidance as to which modalities and protocols may be most appropriate for a new patient. While a physician could recall a similar image taken of a previous patient, retrieve that image, and order the same protocol for a new patient, such a process would be cumbersome, and would be unlikely to result in an optimized protocol for a given patient.

Many modalities come with a database of known protocols. Medical centers can provide physicians access to these databases, allowing the physician to search for a particular protocol for a given modality. One drawback associated with such databases is that they are often modality specific. If a physician wants to order protocols using three different modalities, the physician may have to search three separate databases to find the three desired protocols. It would be desirable to provide a single database containing all protocols for the medical center's modalities.

It is known to use a standard protocol database, such as the American College of Radiology (ACR) Appropriateness Criteria (AC) to search a wide range of protocols associated with various modalities. One drawback associated with such standardized databases is that they do not include custom protocols that the medical center may have developed for their own modalities. Another drawback is that such prior art databases do not maximize collaboration between the physician and the radiologist regarding protocol appropriateness and do not warn when a particular protocol is out of specification for the particular modality or patient history. It would be desirable to provide a database that allowed for the inclusion of custom protocols, better facilitated collaboration between the physician and the radiologist regarding protocol appropriateness, and warned if the ordered protocol is out of specification. The difficulties encountered in the prior art heretofore are substantially eliminated by the present invention.

### SUMMARY OF THE DISCLOSED SUBJECT MATTER

In an advantage provided by this invention, a method for customizing medical imaging protocols is provided.

In an advantage provided by this invention, a method for searching medical imaging protocols is provided.

In an advantage provided by this invention, a method for facilitating collaboration between a physician and a radiologist is provided.

In an advantage provided by this invention, a method for warning of out of specification protocols is provided.

The present invention relates to a method for generating radiological images. A physician examines a patient and submits the client history to a computer system. The system selects protocols associated with modalities accessible to the patient and ranks them in order of appropriateness. The physician selects the desired protocol and orders the protocol. A radiologist receives the protocol and the ranked protocols and decides if the protocol is appropriate. The radiologist may accept the protocol, select a different protocol, collaborate with the physician regarding the appropriate protocol and/or generate a new protocol in view of the patient history. The radiologist then orders the protocol. A technician runs the protocol to generate a radiological image. The radiologist receives the image, generates a report and makes the report and radiological image available to the physician.

### BRIEF DESCRIPTION OF THE DRAWINGS

The present invention will now be described, by way of example, with reference to the accompanying drawings in which:

FIG. 1 is a block diagram of the medical imaging system of the present invention;

FIG. 2 is a block diagram of a webpage showing client history; and

FIG. 3 is a block diagram of a webpage showing a plurality of protocols ranked according to appropriateness.

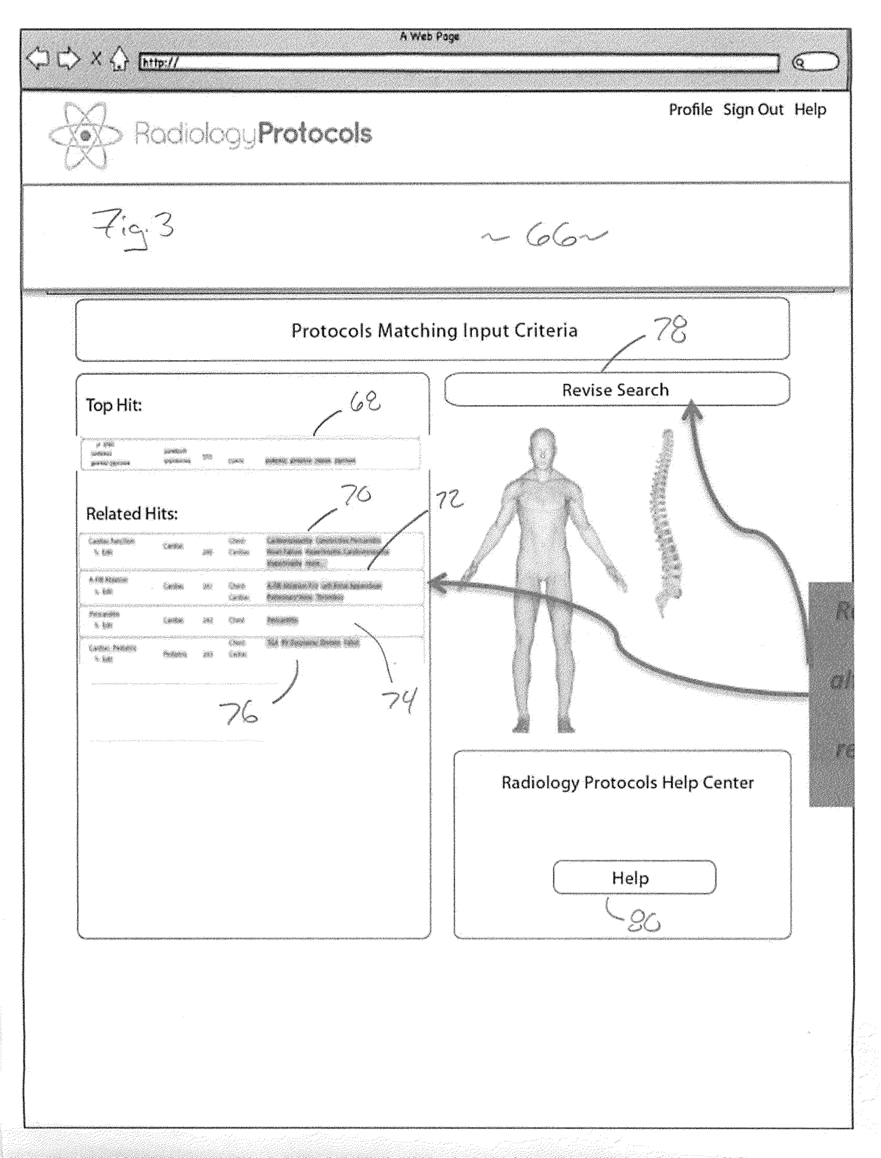

### DETAILED DESCRIPTION OF THE DRAWINGS

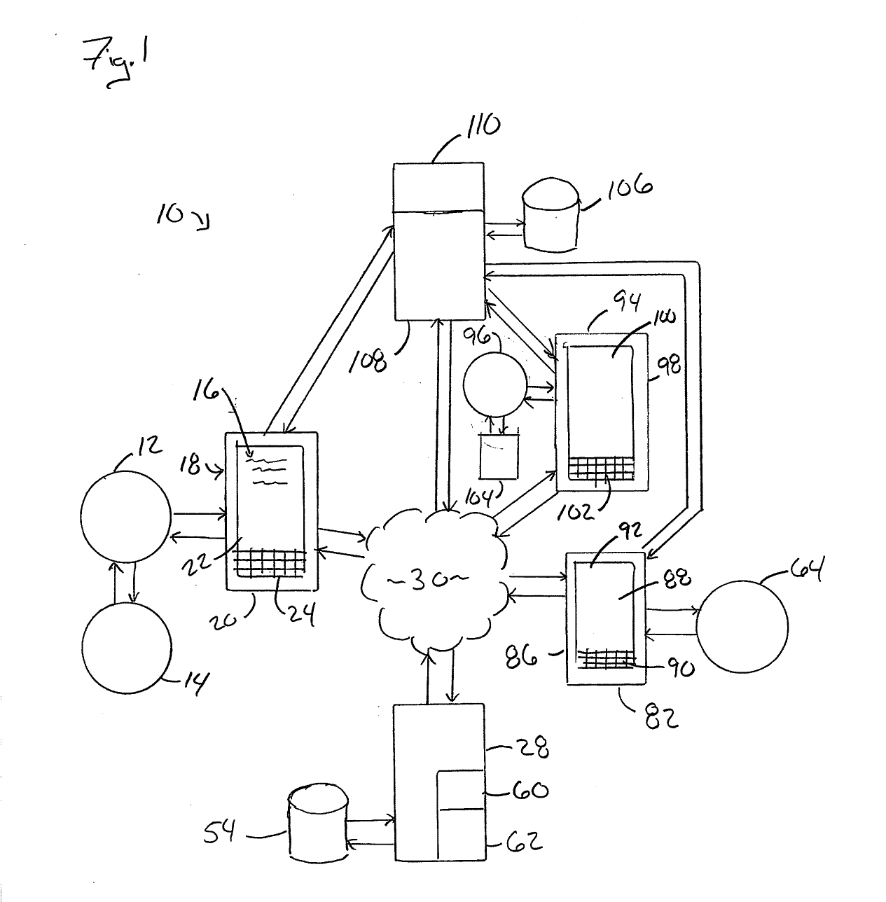

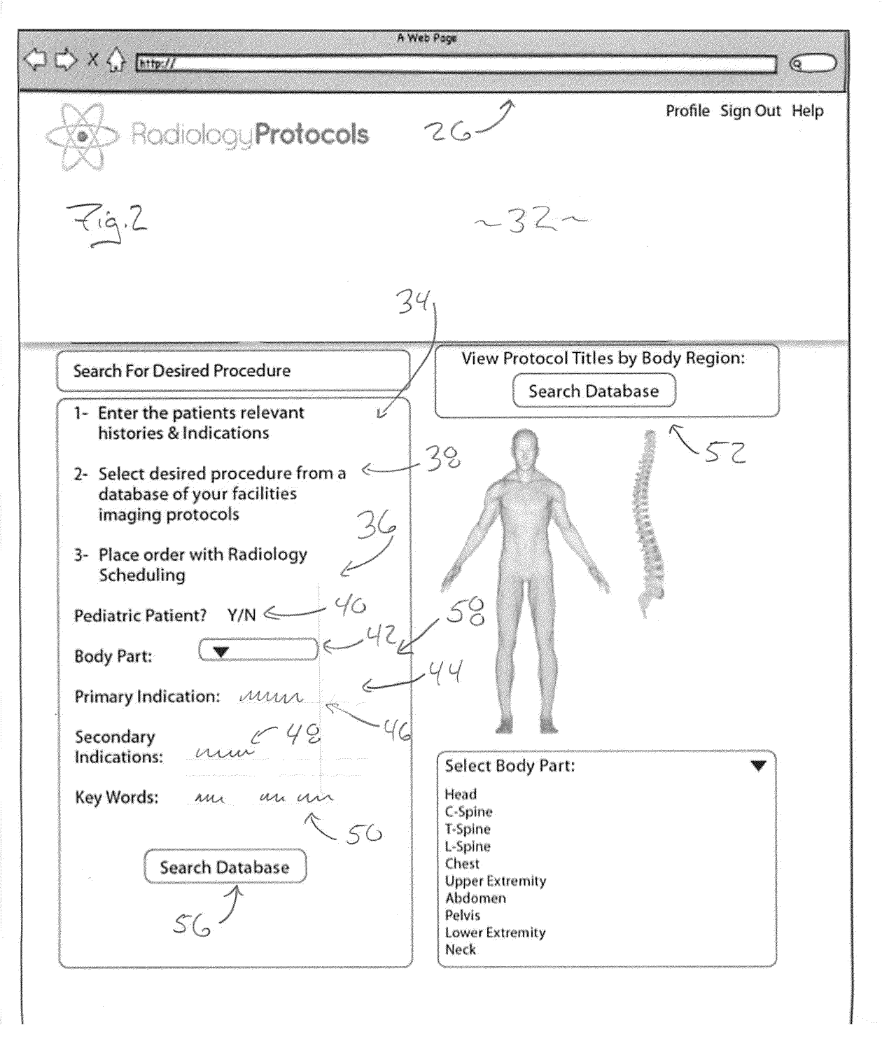

As shown in FIG. 1, a method for selecting medical imaging protocols is shown generally as 10. To begin the process, a physician 12 examines a patient 14 and generates a history 16 in a manner such as that known in the art (FIGS. 1-2). Preferably, the history 16 is recorded on a client 18. The client 18 may include a variety of different computing devices. Examples of client devices are personal computers, digital assistance, personal digital assistance, mobile phones, smart phones, tablet devices, notebook devices, or laptop computers. In the preferred embodiment, the client 18 is a tablet device 20 having a screen 22 and a keyboard 24, which, in the preferred embodiment, is displayed on the screen 22. If after the physician 12 has collected the patient history 16 and the physician 12 determines that medical imaging is indicated, the physician 12 uses the client 18 to execute a browser 26 that connects to a server 28 via a network 30. The network 30 is typically the Internet, but may also be any network, including, but not limited to, a LAN, MAN, WAN, a mobile, a wired or wireless network, a private network, or a virtual private network. Although only a single client 18 and browser 26 are shown, it is to be understood that any desired number of clients or browsers may be supported and can be in communication with the server 28 at any given time. If desired, multiple servers may be used.

When the physician 12 uses the client 18 and the browser 26 to contact the server 28, the server returns a webpage 32, as shown in FIG. 2. As used herein, the term “webpage” means any system providing content, and is not limited to those systems supporting content provided via the Internet or http protocol. In general, functions described herein as being performed on the server side may also be performed on the client side, as appropriate.

As shown in FIG. 2, the webpage 32 presents the physician 12 with an interface 34 with several prompts 36 soliciting the physician 12 to enter information from the client history 16. The webpage 32 may include instructions 38, clickable responses 40 such as a yes/no indicator, drop down menus 42 to indicate the body part involved, and text fields 44 to provide a primary indication 46, a secondary indication 48, and keywords 50. The webpage 32 also includes a search database button 52 that allows the physician 12 to search a protocol database 54 associated with the server 28. Clicking the search database button 52 pulls up another webpage (not shown) allows the physician 12 to search the protocol database 54 by location, modality, patient history, body part, or any other desired search parameters. The webpage 32 is also provided with a search database button 56 that initiates a search of the protocol database 54 using the client history 58 input by the physician 12 onto the webpage 32.

Once the physician 12 clicks the search database button 56, the client 18 sends the patient history 16 across the network 30 to the server 28, which receives the client history 16. A central processing unit 60 associated with the server 28 uses computer executable code 62 to search the protocol database 54 for protocols associated with the patient history 16. Preferably, the software 62 uses an algorithm that sorts protocols in the database 54 by appropriateness, selecting a predetermined number of protocols, such as 10 in the preferred embodiment, via the network 30 to the client 18 for display on the screen 22 of the tablet 20, ranked in order of appropriateness. Preferably, the clicking on the search database button 52 also sends to the server 28 across the network 30, metadata indicating the location of the medical center or facility associated with the tablet 20, physician 12, and/or patient 14. Preferably, the protocol database 54 has information associated with the modalities available at the medical center at which the patient 14 will be examined. The central processing unit 60 of the server 28 uses the software 62 to return only those protocols from the database 54 associated with modalities available at the medical center at which the patient 14 will be examined. Additionally, the database 54 also contains custom protocols associated with either the physician 12, the medical center, and/or a radiologist 64 associated with the medical center, physician 12, or patient 14. If desired, the database 54 may be propagated with existing protocols and modalities provided by modality manufacturers or third parties, such as the American College of Radiology (ACR) Appropriateness Criteria (AC) for any custom protocol selected by the medical center and/or any other desired protocols.

Once the server 28 has used the software 62 to select from the protocol database 54, a plurality of protocols associated with a plurality of modalities associated with the patient history 16 and medical center and the one or more protocols has been received by the client 18 across the network 30, the browser 36 displays the webpage 66, displaying not only the highest rated protocol 68, but the second 70, third 72, fourth 74, and fifth 76 highest rated protocols associated with the medical center and the patient history 16. The physician 12 doing the webpage 66 may use the client 18 to click on any of the displayed protocols 68, 70, 72, 74, or 76, click on the revise search button 78, or the help button 80. If the physician 12 does not find any of the ranked protocols 68, 70, 72, 74, or 76 appropriate for the patient 14, the physician 12 clicks on the revise search button to display a webpage (not shown) which allows the physician 12 to add additional client history, remove client history, search protocols in the database 54 directly, or add additional search criteria, such as changing the location of the medical center at which the patient 14 is to be treated, to increase the number and type of modalities searched. If the physician 12 finds one of the ranked protocols 68, 70, 72, 74, 76 appropriate, the physician 12 selects the desired protocol by clicking on the protocol on the webpage 66.

Upon clicking on the desired protocol, the client 18 sends information regarding the protocol to the server 28 across the network 30. The client 18 may also send metadata associated with the protocol, such as the patient information, patient history 16, location of the medical center, and any other desired information. The server 28 uses the software 68 associated therewith, to send the desired protocol to a client 82 associated with the radiologist 64. Like the client 18, the client 82 is preferably a tablet 86, having a screen 88 and a keyboard 90 provided on the screen 88. The tablet 86 is also provided with a browser 92. Preferably, the browser 92 receives from the server 28 across the network 30, a webpage (not shown) displaying the protocol selected by the physician 12.

The radiologist 64 reviews the protocol selected by the physician 12 and has several options. The radiologist 64 may approve of the protocol by clicking on an approval button (not shown) on the webpage. Alternatively, the radiologist 64 may contact the physician 12 to discuss the appropriateness of the protocol in light of the patient history 16. Alternatively, the radiologist 64 may modify the protocol or may input a completely new protocol into the system 10. Preferably, in the event that the radiologist 64 refuses or modifies the protocol selected by the physician 12, the radiologist 64 will contact the physician 12 to discuss any issues the radiologist 64 has with the protocol selected by the physician 12.

Once the radiologist 64 has approved of the protocol, the radiologist 64 indicates their approval by clicking on an approve button (not shown) or similar indication on the webpage (not shown) indicating that the protocol has been approved. The webpage may be designed such that by clicking on the approval button associated with the protocol, the system 10 automatically orders the protocol or there may be a separate button allowing the radiologist 64 to approve the protocol without ordering it. An example of where the radiologist 64 may wish to approve the protocol without ordering it may be where additional approval such as insurance or a second opinion is desired before the protocol is ordered. Once all the desired approvals have been obtained, the radiologist 64 clicks the approval button associated with the webpage, causing the software 62 associated with the server 28 to order the protocol by sending the protocol to a client 94 associated with a diagnostic imaging technician 96. Preferably, the client 94 is a tablet 98, having a screen 100 and a keyboard 102 displayed on the screen. The technician 96 views a webpage (not shown) displayed on the client 94 to determine the specifications to which to adjust the diagnostic imaging system 104 of modality associated with the protocol. Preferably, all the needed specifications associated with the protocol and modality are provided in the approved protocol. While the diagnostic imaging system 104 may be of any type known in the art, in the preferred embodiment, the modality of preferably computed axial tomography (CAT scan), computed tomography (CT), magnetic resonance imaging (MRI), positron emission tomography (PET), or ultrasound.

Once the technician experienced with the modality sets the modality to the appropriate specification such as scanning speed, contrast, focal point, rotation rate, etc., the technician 96 acquires a radiological image using the approved protocol. In the preferred embodiment, the radiological image or images are in a digital format stored on the computer. Preferably, the image or images are in a Digital Imaging and Communications in Medicine (DICOM) format to facilitate handling, storing, printing, and transmitting the radiological images. Once the radiological images have been acquired, the technician 96 uses the client 94 to upload the images to a database 106 associated with a Radiology Information System (RIS) 108 associated with a Hospital Information System (HIS) 110. The database 106, RIS 108, and HIS 110 may be of any type well known in the art.

Alternatively, the technician 96 may use the client 94 to upload the images to the database 54 or another database (not shown) associated with the server 28 by sending the images across the network 30. However, some administrators may wish to avoid transmitting sensitive patient information, such as the medical images, over the network 30 to maintain compliance with various laws and internal protocols.

As shown in the FIG. 1, the client 18 associated with the physician 12 and the client 82 associated with the radiologist 64 are also connected to the RIS 108 and HIS 110, thereby allowing the physician 12 and radiologist 64 to access the medical images acquired of the patient 14 by the technician 96. Preferably, before the physician 12 examines the images, the radiologist 64 will use the client 82 to download the image from the database 106 associated with the RIS 108 so that the radiologist 64 may examine the image and generate or prepare a radiological exam of the image. Preferably, the radiologist 64 inputs the radiological exam into the client 82 which the system associates with a medical image in the database 106 of the RIS 108. After the radiologist 64 has generated the exam and uploaded the exam to the database 106, the physician 12 may download the radiological image and exam to the client 18 for use in diagnosis and/or treatment of the patient 14.

Although the invention has been described with respect to a preferred embodiment thereof, it is to be understood that it is not to be so limited since changes and modifications can be made therein which are within the full, intended scope of this invention as defined by the appended claims.

What is claimed is:

1. A computer-implemented method for generating radiological images, performed on one or more computing devices, the method comprising:
(a) receiving, using the one or more computing devices, across a global communications network, a patient history associated with a location;
(b) identifying, using the one or more computing devices, one or more protocols, selected from a protocol database of a plurality of protocols associated with a plurality of modalities, wherein the one or more protocols are associated with the patient history and with a modality associated with the location;
(c) receiving, using the one or more computing devices, across the global communications network, the one or more protocols;
(d) selecting, using the one or more computing devices, a protocol, from the one or more protocols to produce a selected protocol;
(e) receiving, using the one or more computing devices, the selected protocol;
(f) reviewing, using the one or more computing devices, the selected protocol to produce a reviewed protocol;
(g) approving, using the one or more computing devices, the reviewed protocol, to produce an approved protocol;
(h) ordering, using the one or more computing devices, the approved protocol;
(i) acquiring radiological images using the approved protocol;
(j) receiving, using the one or more computing devices, the radiological images;
(k) generating, using the one or more computing devices, an exam based upon the radiological images; and
(l) uploading, using the one or more computing devices, the exam to an exam database.

2. The computer-implemented method of claim 1, wherein the database of the plurality of protocols associated with a plurality of modalities, includes at least one modality not associated with the location.

3. The computer-implemented method of claim 1, wherein the one or more protocols comprises at least two protocols.

4. The computer-implemented method of claim 3, further comprising ranking, using the one or more computing devices, the at least two protocols in order of appropriateness for the patient.

5. A computer-implemented method for generating radiological images, performed on one or more computing devices, the method comprising:
(a) receiving, using the one or more computing devices, from a physician, across a global communications network, a patient history associated with a location;
(b) identifying, using the one or more computing devices, one or more protocols, selected from a protocol database of a plurality of protocols associated with a plurality of modalities, wherein the one or more protocols are associated with the patient history and with a modality associated with the location;
(c) receiving, using the one or more computing devices, across the global communications network, the one or more protocols;
(d) selecting, using the one or more computing devices, by the physician, a protocol, from the one or more protocols to produce a selected protocol;
(e) receiving, using the one or more computing devices, the selected protocol;
(f) reviewing, using the one or more computing devices, by a radiologist, the selected protocol to produce a reviewed protocol;
(g) approving, using the one or more computing devices, by the radiologist, the reviewed protocol, to produce an approved protocol;
(h) ordering, using the one or more computing devices, the approved protocol;
(i) acquiring radiological images using the approved protocol;
(j) receiving, using the one or more computing devices, the radiological images;
(k) generating, using the one or more computing devices, by the radiologist, an exam based upon the radiological images;
(l) receiving, using the one or more computing devices, the exam; and
(m) reviewing, using the one or more computing devices, by the physician, the exam.

6. The computer-implemented method of claim 5, wherein the database of the plurality of protocols associated with a plurality of modalities, includes at least one modality not associated with the location.

7. The computer-implemented method of claim 5, wherein the one or more protocols comprises at least two protocols.

8. The computer-implemented method of claim 7, further comprising ranking, using the one or more computing devices, the at least two protocols in order of appropriateness for the patient.

9. The computer-implemented method of claim 5, further comprising:
(a) modifying, using the one or more computing devices, by the radiologist, the reviewed protocol prior to approving the reviewed protocol;
(b) receiving, using the one or more computing devices, by the physician the approved protocol; and
(c) authorizing, using the one or more computing devices, by the physician, the approved protocol.

10. A computer-implemented method for generating radiological images, performed on one or more computing devices, the method comprising:
(a) generating, using the one or more computing devices, at a location, a recommended protocol;
(b) receiving, using the one or more computing devices, across a global communications network, the recommended protocol;
(c) uploading, using the one or more computing devices, the recommended protocol to a protocol database of a plurality of protocols associated with a plurality of modalities and a plurality of locations;
(d) receiving, using the one or more computing devices, across a global communications network, a patient history associated with the location;
(e) identifying, using the one or more computing devices, the recommended protocol from the protocol database, wherein the recommended protocol is associated with the patient history and with a modality associated with the location;
(f) receiving, using the one or more computing devices, across the global communications network, the recommended protocol;
(g) selecting, using the one or more computing devices, the recommended protocol;
(h) receiving, using the one or more computing devices, the recommended protocol;
(i) reviewing, using the one or more computing devices, the recommended protocol;
(j) approving, using the one or more computing devices, the recommended protocol;
(k) ordering, using the one or more computing devices, the recommended protocol;
(l) acquiring radiological images using the recommended protocol;
(m) receiving, using the one or more computing devices, the radiological images;
(n) generating, using the one or more computing devices, an exam based upon the radiological images; and
(o) uploading, using the one or more computing devices, the exam to an exam database.

11. The computer-implemented method of claim 10, wherein the database of the plurality of protocols associated with a plurality of modalities, includes at least one modality not associated with the location.
